(19) United States
(12) Patent Application Publication
(10) Pub. No.: US 2021/0125250 A1
(43) Pub. Date: Apr. 29, 2021

(54) System for Facilitating Customer Interactions in Fitting Rooms

(71) Applicant: ZEBRA TECHNOLOGIES CORPORATION, Lincolnshire, IL (US)

(72) Inventors: Jeffrey B. Wilhite, Barrington, IL (US); Dale W. Russell, Palatine, IL (US); Valik Solorzano Barboza, Glenview, IL (US); Matthew B. Hayes, Wheaton, IL (US)

(21) Appl. No.: 17/078,823

(22) Filed: Oct. 23, 2020

Related U.S. Application Data
(60) Provisional application No. 62/925,098, filed on Oct. 23, 2019.

(51) Int. Cl. G06Q 30/06; G06Q 10/06; G06K 7/10; G06Q 50/28; G06F 16/242; G06F 3/16

(52) U.S. Cl. CPC G06Q 30/0613; G06Q 10/06311; G06F 3/167; G06Q 50/28; G06F 16/243; G06K 7/10297

(57) ABSTRACT

Systems and methods for facilitating customer interactions, such as customer evaluation of goods, are provided. Sensor input relevant to items selected by a customer is received by an interactive device, which creates a contextual element based on the sensor input and previously provided configuration data. The device receiving a voice command from a customer. The voice command is parsed into a logical command. The logical command is associated with the contextual element and the associated contextual element and logical command are transmitted to an associate, such that the associate is prompted to respond to the logical command.

### CROSS-REFERENCE TO RELATED APPLICATIONS

This application claims benefit of U.S. Provisional Patent Application Ser. No. 62/925,098 filed Oct. 23, 2019, the contents and disclosures of which are incorporated herein by reference in their entirety for all purposes.

### BACKGROUND

Shoppers commonly use fitting rooms to try on garments that they are considering purchasing. The experience of using a fitting room, though, is made difficult by the need to bring in only a few garments at a time. If, upon being tried on, garments don't fit well, or otherwise aren't suitable to the shopper, they must be returned to store racks or inventory. The shopper may have to find other sizes or colors that are more acceptable, then re-enter the fitting room. In some cases, an associate may serve the function of running items from the shop floor or inventory to the fitting room as needed by a shopper, but the shopper still needs to communicate his or her preferences to the associate helping them. This adds to the time and effort required by both the shopper and associate in finding appropriate and desirable garments for the shopper.

A system that facilitates the process of using fitting rooms, and of identifying and meeting customer preferences and needs, would add to the efficiency of the fitting process and make the process easier and more enjoyable for both the shopper and associate.

### SUMMARY

In one embodiment, the present invention is a method for facilitating customer interactions such as customer evaluation of items in which sensor input relevant to items selected by a customer is received, a contextual element based on the sensor input and previously provided configuration data is created, a voice command from the customer is received and parsed into a logical command, the logical command with the contextual element are associated with one another, and the associated contextual element and logical command are transmitted to an associate, such that the associate is prompted to respond to the logical command.

In another embodiment, the present invention is a device including memory storing configuration data that receives sensor input, creates a contextual element based on the sensor input and the configuration data, receives audio, associates the audio with the contextual element, and transmits the associated element and audio to a party who can provide assistance to a user of the device.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a system for facilitating customer interactions; and

FIG. 2 illustrates a block diagram of steps involved in using voice commands to facilitate a customer experience in one embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

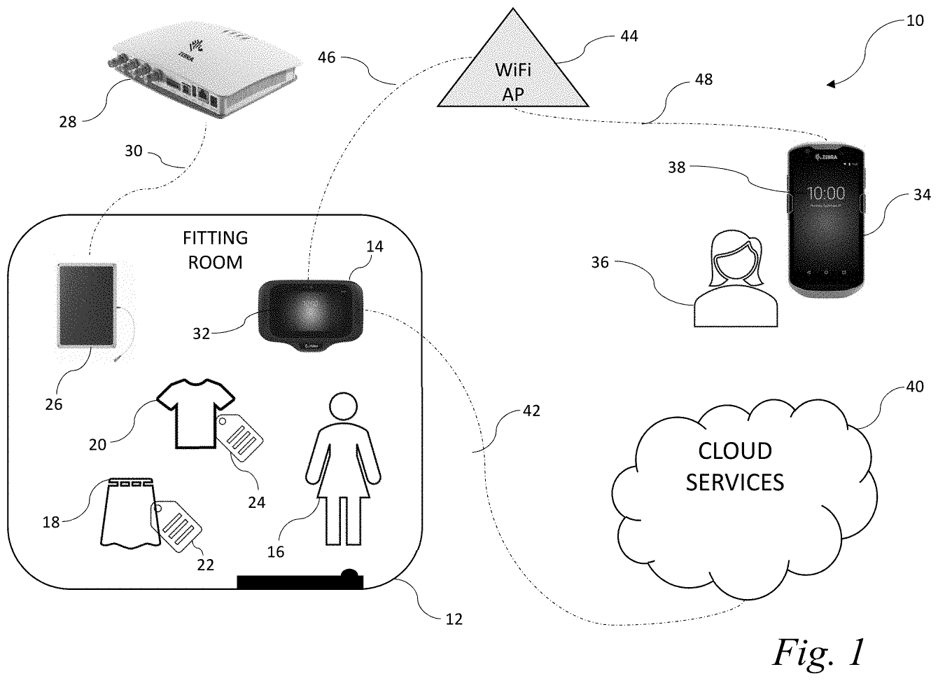

One embodiment of the present invention is shown in FIG. 1. In a customer facilitation system 10, a fitting room 12 is provided with an interactive device 14 that provides services to assist a customer 16 in evaluating items, such as trying on garments 18 and 20. While only two garments are shown in FIG. 1, it is to be understood that systems and methods of the present invention may be used to facilitate the trying on or purchase of many garments or other items. The garments 18 and 20 are provided with RFID tags 22 and 24, respectively, which are unique to the garments. Each item (such as the garments 18 and 20) has one or more attributes, such as a stock keeping unit (SKU) number, size, color, price, unique identifier, or other item data associated with it, and these details are associated in systems and method of the present invention with information on the RFID tags. In some embodiments, this information may be stored directly within the RFID tags. Certain items may also have image data associated with the items.

Also provided within or near the fitting room 12 is an RFID antenna 26 adapted to read the RFID tags 22 and 24 in connection with an RFID reader 28. The RFID antenna 26 may be situated to detect only RFID tags within the fitting room 12 or within a small portion of the fitting room 12. For example, the RFID antenna 26 may be situated or adapted to read RFID tags only for garments that are hung on a specific hanger within the fitting room 12 or within a defined region of the fitting room 12. However, it is preferred for the RFID antenna to be adapted to sense all of the RFID tags associated with all of the garments or other items in the fitting room 12.

In one embodiment, the RFID tags 22 and 24 comprise a substrate that may be printable, an antenna, a processor, and a memory comprising a unique tag ID (Electronic Product Code (EPC)). In one embodiment, the RFID tags 22 and 24 and the RFID reader are compatible with the Gen2 protocol.

The interactive device 14 is preferably provided with a touchscreen 32 which integrates a visual display with a touchable user interface. The interactive device further includes a housing suitable for mounting in the fitting room 12, a microphone, a speaker, a processor, memory such as a removable SD card, a communication module, and software such as an operating system and an application.

The RFID antenna is communicatively connected to an RFID reader 28, either wirelessly or via a wired connection, as shown by communication pathway 30. The RFID reader 28 includes a housing suitable for mounting in or near the fitting from 12, a processor, a communication module, and operating software/firmware.

As will be explained in further detail, the customer 16 interacts with the interactive device 14 via spoken interactions with a voice-based interface of the interactive device 14, or via touch or other UI techniques. In turn, the interactive device 14 may, either directly or via intermediate devices, send and receive signals to and from one or more mobile devices 34 used by an associate 36, such as a sales associate or another member of store personnel.

The mobile device 34 has a touchscreen interface 38 allowing associate 36 to interact with the customer 16 to facilitate the fitting room experience, as further explained below. The mobile device 34 further comprises a housing, memory, processor, communication module, power module (e.g. battery), and user interface elements such as a keypad, a microphone, and a speaker.

Also provided within the system 10 is a server including a processor, memory, communication module, and software such as a voice engine and a machine learning processor. In the embodiment shown in FIG. 1, this server is a cloud-based server and is shown by the cloud services 40. A communication pathway 42, which may be via the internet, is provided between the cloud services 40 and the interactive device 14.

A Wi-Fi access point 44 may also be provided. In the embodiment shown in FIG. 1, the Wi-Fi access point 44 provides a first communication pathway 46 between the interactive device 14 and the Wi-Fi access point, and a second communication pathway 48 between the access point 42 and the mobile device 34.

Communication between electronic components of the present invention (such as the interactive device 14, the RFID reader 28, the mobile devices 34) and the server such as embodied by the cloud services 40 may be via an ad-hoc wireless network that forms between these devices, or through a centralized communication hub. Communications between devices of the present invention are preferably via wireless communication such as under the Wi-Fi communications standards, though other communications techniques may be used in some embodiments. Devices may communicate via cellular communications.

Further, it is to be understood that processing and data storage may be carried out in a variety of ways. For example, the interactive device 14 may be provided with processing power and required applications to parse verbal statements and to present information to the mobile devices 34 without any need for external servers to provide this function. In one embodiment, the functions carried out by the server (such as represented by the cloud services 40) may be carried out by a combination of the interactive device 14 and the mobile devices 34.

In one embodiment of the present invention, the interactive device 14 is a CC6000 “Customer Concierge” kiosk as available from Zebra Technologies Corp., and the mobile device 34 is TC56 touch computer, also as available from Zebra Technologies Corp.

In one embodiment of the present invention, elements of the system 10 are configured before the system is enabled to facilitate a product evaluation and purchase process.

During configuration, one or more RFID tags 22 and 24 are associated with items such as garments 18 and 20. Item attributes of the items are written to memory on the RFID tags 22 and 24, or item attributes are written to a memory (for example, of the cloud services 40 or the interactive device 14) along with the tag unique identifier (UID) or electronic product code (EPC). This collection of data, along with other data relevant to the operation of the system, may be considered configuration data, and may be stored in a variety of logical or memory locations within systems of the present invention.

The RFID reader 28 is configured with the communication protocol of the RFID tags, powered, and mounted in or near the fitting room 12. The antenna 26 is adjusted to read tags within the fitting room 12 and preferably not to interrogate or read tags not in the room.

Image data associated with the items is pre-loaded into memory of the interactive device 14. In some embodiments, this image data may be pre-loaded into the mobile devices 34 or the cloud services 40.

The interactive device 14 and RFID reader 28 are configured to communicate with each other via their respective communication modules.

The interactive device 14 and the mobile devices 34 are configured to communicate with the cloud services 40 via their respective communication modules.

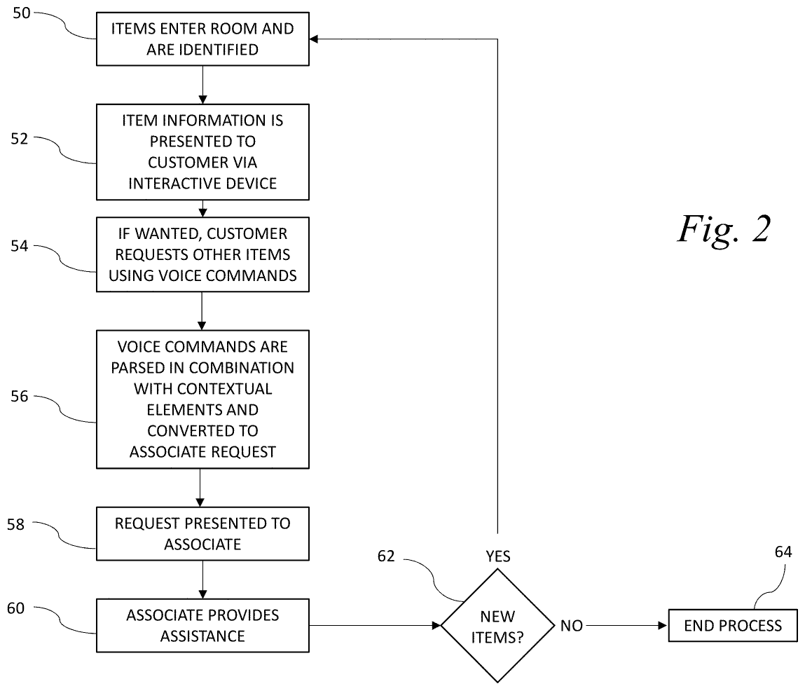

With reference to FIGS. 1 and 2, an item evaluation and customer facilitation process will now be described. FIG. 2 displays a generalized flow of functions performed by systems and methods of the present invention.

A product evaluation process can then proceed when a customer 16 selects items 18 and 20 having RFID tags 22 and 24 and carries the tagged items into the fitting room 12. The RFID reader 28, via the antenna 26, reads the tags 22 and 24 by interrogating the tags and receiving signals from the tags. This step is illustrated at block 50 in FIG. 2.

In one embodiment, the RFID reader is consistently in an interrogation mode so that it can identify the entry of new RFID tags into the fitting room 12. The RFID reader 28 may singulate the tags, with the tags undergoing a singulation round.

The RFID reader 28 requests tag IDs, the tags 22 and 24 receive the read request and respond to the read request so that the RFID reader 28 receives the tag IDs. Once new tag IDs have been identified, a room entry event is created. The creation of the room entry event may be transmitted from the RFID reader 28 to the interactive device 14.

The interactive device 14 receives the room entry event and creates a contextual element for the event. In this case, the contextual element could be considered a “customer in fitting room” element. The contextual element may contain several pieces of data about the event, including details of the items in the fitting room 12 (such as SKU numbers) and any details known about the customer 16. A greeting is selected by the interactive device 14 and broadcast, preferably via a speaker on the interactive device 14, to the customer. The RFID reader 28 transmits data corresponding to the RFID tags 22 and 24 to the interactive device 14, which receives the tag data.

The interactive device 14 modifies the contextual element to add the tag data and associates the tag data with item data and images. The interactive device 14 then selects images to display on the screen 32, based on the contextual element. The displayed image may include information on available variations of the items, including different sizes and colors. The screen 32 renders and displays item images, which are viewed by the customer 16, as shown at block 52 of FIG. 2. The customer may be provided with visual or verbal instructions on how to address voice commands to the interactive device 14.

At this point, the customer may try on the items 18 and 20 or otherwise evaluate the items. The customer may then make a verbal request or voice command for an item, which is received at a microphone of the interactive device. For example, the customer could say “I like this shirt, but I want it in size medium.” This step is illustrated at block 54 of FIG. 2.

A number of different voice commands may be processed by systems of the present invention. Example commands include:

“I need item 1 in size X” where X is a size number.

“I need item 2 in a Y size,” where Y is a size descriptor such as extra small, small, medium, large, or extra large.

“I need item 1 in Z sizes smaller/larger” where Z is a number from 1 to 4.

“I need item 3 in the color (blue, black, red, etc.)”

Next, as shown at block 56 of FIG. 2, the voice commands are parsed in combination with a contextual element of the process (such as information that this is a fitting room process). In one embodiment, the interactive device 14 digitizes the audio and transmits the audio and other information regarding the contextual element to a server such as provided by the cloud services 40. In this embodiment, the server receives the audio and contextual element information and carries out a number of functions. Customer intent is determined based on this parsing. The server processes the audio with a voice processing engine and associates intent output from the voice engine with the contextual element. The server then determines the item that is being requested by the customer. In this example, the requested item would be a shirt matching the style and color of the shirt chosen by the customer, but in a medium size.

The voice command is parsed into a logical command that may be conveyed to the associate 36 via the mobile device 34. In one example, the server may compare the requested item to a store inventory, and if the requested item is in the store inventory, the associate 36 is notified of the customer's request (for example, via the mobile device 34), as shown at block 58 of FIG. 2. The associate 36 may confirm request of this receipt. In this step, the server creates a message for the associate 36 and transmits the message, which is received by the mobile device 34. The server may also send a signal to the interactive device 14 so that the customer 16 can be informed that the associate will bring the item to the fitting room 12. If the server is not capable of translating the voice command into a logical request to be presented to the associate 36, the customer 16 can be notified of this via the interactive device 14 and prompted via the interactive device (for example, via the touchscreen interface) to make a different request or to repeat the request, but phrased differently. In some cases, the customer may be prompted to insert a new request via a non-voice user interface on the interactive device.

If the server determines that the requested item is unavailable, the server can send a signal to the interactive device 14 so that the interactive device 14 informs the customer 16 that the item isn't currently available. For example, the interactive device can display or announce “Unfortunately we do not have that (size or color) but we can ship it to you in 2 days, returns are always free. Are you interested?”

In one embodiment, both the interactive device 14 and the server contain voice processing capabilities. The interactive device 14 may remove noise and do basic speech processing, while the server carries out a translation of voice commands into logical commands for presentation to the associate 36. In another embodiment, the interactive device is capable of completing all required voice processing and translation into logical commands and sending those commands to associate 36 via the mobile device 34.

The mobile device 34 displays the message and receives input from the associate 36 confirming receipt of the message. Confirmation is transmitted to the server, which receives the confirmation. The associate provides assistance as shown at block 60 of FIG. 2, for example by bringing a requested item to the fitting room 12.

If the item was not found, a message is created by the server to indicate that to the customer 16, and that message is sent by the server to the interactive device 14 and communicated to the customer 16 via an audio message or an image. The customer may then request a different item again or may decline to continue asking for different items. Such requests may continue from the customer 14 and continue to be processed by the server and provided to the associate 36 via the mobile device 34 until the customer's requests stop.

As part of this process, the associate 36 may be instructed to bring requested items to the fitting room 12 for further evaluation by the customer 16. As shown at decision block 62 of FIG. 2, if new items are brought to the fitting room 12, those items enter the room and are identified as shown at block 50. If no new items are requested, or if for any other reason no new items are brought to the fitting room (such as for out-of-stock items), the customer can be informed of this via the interactive device 14 and the process ends as shown at block 64 of FIG. 2.

It is to be understood that the term “fitting room” is used herein to refer to a variety of different types of rooms or areas where garments or other items may be tried on or evaluated. A “fitting room” may in some cases be called a dressing room, for example.

In some embodiments, the customer 16 can interact with the interactive device 14 to inform the associate 36 to bring a desired product directly to a sales counter rather than to the fitting room 12. Further, the interactive device 14 may present the customer 16 with an icon so that the customer can choose to interact with the device 14 using only visual means, which could be necessary if the customer is hearing impaired. The interactive device 14 may also present the customer with a help icon so that the customer can summon an associate to the fitting room 12 when needed.

While examples have been provided in which a customer is trying on garments, it is to be understood that systems and methods of the present invention may be adapted to allow customers or other users to evaluate a wide variety of different types of items. For example, in SOME embodiments a customer or user may use systems and methods of the present invention to help evaluate electronic devices or other consumer goods, musical instruments, or games. Further, systems and methods of the present invention may be used in non-consumer deployments such as in a yard management system, where the items are goods to be transported and the user uses voice commands to input requests regarding those goods. Rather than a fitting room, the principles of the present invention can be applied to any region where tagged items are assembled.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components carrying out the functions described in the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions.

The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for facilitating a customer interaction comprising:
receiving sensor input relevant to items selected by a customer;
creating a contextual element based on the sensor input and previously provided configuration data;
receiving a voice command from the customer;
parsing the voice command into a logical command;
associating the logical command with the contextual element; and
transmitting the associated contextual element and logical command to an associate, such that the associate is prompted to respond to the logical command.

2. A device for facilitating a customer evaluation of one or more items comprising:
memory storing configuration data relevant to the one or more items;
a data interface adapted to receiving sensor input relevant to the one or more items;
a microphone adapted to receive voice commands; and
a processor adapted to create a contextual element based on the sensor input and the configuration data, to parse the voice command into a logical command, and to associate the logical command with the contextual element; and
a transmitter adapted to transmit the associated contextual element and logical command to a mobile device.

3. The device of claim 2 further comprising a housing configured for mounting in a fitting room.

4. The device of claim 2 further comprising a plurality of user interface elements that are adapted to receive a message, associate it with the contextual element, and presents it via one of the plurality of elements chosen based on the contextual element.

5. Software configured to receive a contextual element and audio, process the audio with a voice processor to produce intents, associate the intents with the contextual element, and produce a query based on the associated data.

6. The software of claim 5 further configured to determine, based on the query results and the contextual element, a preferred remote device to receive instructions, generate the instructions, and transmit them to the preferred remote device.

7. The software of claim 6 where the contextual element and audio are received from a first remote device and the preferred remote device is the first remote device.

8. The software of claim 6 where the contextual element and audio are received from a first remote device and the preferred remote device is a second remote device.

9. The software of claim 8 where the software is further configured to receive data from the second remote device in response to the instructions, format a second message based on the response and the contextual element, and transmit the second message to the first remote device.

10. A system comprising:
an interactive device for facilitating a customer evaluation of one or more items comprising:
memory storing configuration data relevant to the one or more items;
a data interface adapted to receiving sensor input relevant to the one or more items;
a microphone adapted to receive voice commands; and
a processor adapted to create a contextual element based on the sensor input and the configuration data, to parse the voice command into a logical command, and to associate the logical command with the contextual element; and
a transmitter adapted to transmit the associated contextual element and logical command to a mobile device; and
an RFID reader configured to monitor a region in which the interactive device is placed;
wherein the configuration data associates the RFID reader with the interactive device.

11. The system of claim 10 where the RFID reader is further configured to capture tag data for tags associated with the one or more items, including a tag unique identifier, and to transmit the tag data to the interactive device.
